(19) United States
(12) Patent Application Publication
(10) Pub. No.: US 2021/0115605 A1
(43) Pub. Date: Apr. 22, 2021

(54) Nonwoven molded article

(71) Applicant: Johann Borgers GmbH, Bocholt (DE)

(72) Inventor: Michael KALWEIT, Bocholt (DE)

(21) Appl. No.: 17/050,471

(22) PCT Filed: Mar. 21, 2019
(86) PCT No.: PCT/EP2019/057104

§ 371 Date: Oct. 26, 2020

(30) Foreign Application Priority Data
Apr. 27, 2018 (DE) 10 2018 110 246.1

(51) Int. Cl. D04H 1/541; D04H 1/4382; D04H 1/485

(52) U.S. Cl. CPC D04H 1/541; B62D 25/161; D04H 1/485; D04H 1/43828

(57) ABSTRACT

A nonwoven molded article may include at least one thermoformed nonwoven fabric. The fabric may include structural fibers having polyethylene terephthalate, first bicomponent binder fibers, optional second binder fibers, and optional additives. The first bicomponent binder fibers may include matrix-forming polyethylene-terephthalate having a semicrystalline sheathing material having a melting point ranging from 90 to 175° C. The optional second bicomponent binder fibers may include matrix-forming polyethylene-terephthalate having a semicrystalline sheathing material and differ from the first bicomponent binder fibers.

### CROSS-REFERENCE TO RELATED APPLICATIONS

The present application is a national stage entry according to 35 U.S.C. § 371 of PCT application No.: PCT/EP2019/057104 filed on Mar. 21, 2019; which claims priority to German Patent Application Serial No.: 10 2018 110 246.1 filed on Apr. 27, 2018; all of which are incorporated herein by reference in their entirety and for all purposes.

### TECHNICAL FIELD

A nonwoven molded article, in particular for the covering of vehicle floor regions or for wheel arch shells of motor vehicles, comprising at least one thermoformed nonwoven fabric formed from structure-providing polyethylene terephthalate fibers and from matrix-forming polyethylene-terephthalate-containing bicomponent binder fibers is disclosed.

### BACKGROUND

Nonwoven molded articles used in vehicles in the automobile industry are composite materials which are formed from structure-providing fiber components and from matrix-forming fiber components. These fibers are generally made in the form of a nonwoven, and then, in an optionally multistep thermal shaping process, converted, in particular pressed, into the desired shape.

The nonwoven molded articles of this type are used by way of example in vehicles as wheel arch shells, underbody cladding, trunk side walls and parcel shelves.

These wheel arch shells formed from nonwoven molded articles are known for example from DE 20 2005 015 164 U1. The wheel arch shells described in that document, however, have a low heat deflection temperature of about 90° C.; they, moreover, exhibit relatively high water absorption and consequently delayed water release. They also have relatively high combustibility.

### SUMMARY

It is therefore an aspect to provide a nonwoven molded article which overcomes the disadvantages described above.

The inventors have achieved this object by providing at least one thermoformed nonwoven fabric formed from
A) structure-providing polyethylene terephthalate fibers;
B) matrix-forming polyethylene-terephthalate-containing bicomponent binder fibers which have a semicrystalline sheathing material with a melting range of 90 to 175° C.;
C) optionally matrix-forming polyethylene-terephthalate-containing bicomponent binder fibers which have a semicrystalline sheathing material and differ from the bicomponent binder fibers B); and
D) optionally additives.

The object is also achieved via a process for the production of a nonwoven molded article, comprising the steps of:
i) laying of at least one nonwoven fabric by means of a carding-cross lay process or of an aerodynamic nonwoven-formation process,
ii) followed by needling of the nonwoven fabric(s) or of the nonwoven fabric(s) thus formed and
iii) cutting to size,
iv) heating and
v) thermoforming of the nonwoven fabric(s) to give the desired nonwoven molded article.

The object is also achieved via the use of the nonwoven molded article as wheel arch shell, underbody cladding, trunk side wall or parcel shelf.

### DETAILED DESCRIPTION

A bend is defined as 1 sine wave=360°.

Melting ranges and softening ranges, and melting points and softening points, are determined by means of differential scanning calorimetry (DSC) in accordance with DIN EN ISO 11357-3: 2013-04.

The person skilled in the art in the field of polymers is aware of the term semicrystalline, and is able to determine the semicrystallinity of polymers or mixtures thereof by means of DSC measurements. The materials of the sheathing material (also termed sheath) of the bicomponent binder fibers B) and C) respectively have specific melting ranges. This means that the peak maxima of the respective melting points and/or softening points (termed melting peaks for the purposes) in the curve determined by means of DSC are located within this range.

The structure-providing polyethylene terephthalate fibers A) here may be either solid fibers or hollow fibers. The hollow fibers have lower weight than solid fibers for the same diameter, but by virtue of their configuration as hollow bodies have adequate strength values, in particular in relation to stiffness. Use of hollow fibers therefore allows production of nonwoven molded articles which have lower weight while their intrinsic stiffness values remain adequate, in particular do not decrease.

The matrix-forming polyethylene-terephthalate-containing bicomponent binder fibers B) which have a semicrystalline sheathing material, have the abovementioned properties. The sheathing material is moreover a thermoplastic material, such as a hot-melt adhesive.

All of the fibers A) to C) described here are obtainable commercially.

In order to produce adequate binder of the fibers to one another, the fibers A) and B) and optionally C) are present in a respective fiber mixture. These fibers B) and C) have, at least in their respective sheath region, a reduced melting and/or softening ranges in comparison with the fibers A), so that when these are in contact with other fibers they form binder points or binder regions at the areas of contact with the other fibers.

The mixture of various fiber types may be adapted to the respective intended purpose and to the properties of a respective nonwoven fabric that are required for this purpose. The proportion by weight of fibers A) here is advantageously greater, or at least equal to, the proportion by weight of fibers B) or fibers B) and C).

By virtue of the specific mixture of the fiber A) and B) or A) to C), it becomes possible to obtain a nonwoven molded article which features reduced water absorption, in particular water wicking <5 mm, rapid water release, and low component weight. The nonwoven molded article is moreover dimensionally stable during long periods of exposure to heat at about 120° C., and is weathering-resistant. The SE/NBR requirements for low combustibility relating to cars, lorries, buses, land vehicles, and vehicles in general may be met.

If the nonwoven molded article contains at least one polar compound which has oleophobic effect, the surface tension of the component is altered, and an advantageous repellent effect in relation to media such as water, dirt and ice is developed at the surface of the nonwoven fabric. All of the polar compounds having oleophobic effect that are known to the person skilled in the art in the field of fibers are generally suitable here. These are in particular fluorinated or perfluorinated hydrocarbon compounds. Suitable compounds are disclosed by way of example in U.S. Pat. No. 5,143,963, EP 1 000 184 A1 or U.S. Pat. No. 4,767,545. Fluorinated or perfluorinated hydrocarbon compounds having 3 to 15 carbon atoms, such as 4 to 14 carbon atoms, are likewise suitable. The polar compounds having oleophobic effect here are contained in 0.00001 to 5% by weight, such as 0.001 to 2.5% by weight, or from 0.01 to 1% by weight, based on the total weight of the nonwoven molded article.

The nonwoven molded article may also contain at least one additive, such as pigments, dyes, antioxidants, processing aids and antistatic agents.

With the aid of a fiber mixture it is also possible to process a plurality of nonwoven fabrics in a layer stack. In another embodiment it is therefore advantageous that a plurality of nonwoven fabrics are arranged, one above the other in a layer stack, to form a multilayer nonwoven molded article.

The weight per unit area of the nonwoven molded articles is greatly reduced by stretching at the deepest spatial point of the formation; by way of example mention may be made of 1310/530/1410 g/m² variation in longitudinal direction and/or of 1440/480/1470 g/m² variation of weight per unit area in transverse direction. In a non-limiting embodiment, they have 2.34/1.32/2.36 mm thickness variation in longitudinal direction and/or 2.36/1.33/2.35 mm thickness variation in transverse direction. It is likewise that bulk density in longitudinal direction is 559.8/401.5/597.5 kg/m³ and/or that bulk density in transverse direction is 610.2/360.9/625 kg/m³. The bulk density here is calculated at weight per unit area/thickness quotient.

Use of the fiber mixture for production of a textile wheel arch shell is particularly advantageous, and is likewise provided. The wheel arch shell here may be constructed as described in DE 20 2005 015 164 U1, with the nonwoven fabric replacing the nonwoven fabric disclosed in that document.

Finally, in an embodiment, a particularly advantageous process consists in production of the nonwoven molded article via laying of at least one, such as cross laid, nonwoven fabric by means of a carding-cross lay process or of an aerodynamic nonwoven-formation process, followed by needling of the nonwoven fabric(s) or of the nonwoven fabric(s) thus formed and cutting to size, heating and thermal, in particular thermoplastic, shaping of the nonwoven fabric(s) to give the desired nonwoven molded article.

For the needling, fine felting needles, such as felting needles of 15×16×36 3.5″ M332 G 53 037 type may be used.

### EXAMPLES

Tests for low combustibility, water absorption and water release

### Example 1

60% by weight of wellene PET PPS 0104079 from Wellman-Indorama, a PET fiber containing fluorocarbon compounds (fiber A).

40% by weight of wellbond PET Bico M 1439 from Wellman-Indorama, which has a melting peak at about 110.6° C., a melting peak at about 154° C. (both sheath) and another melting peak at about 251.1° C. (core) in the DSC, the core consisting of polyethylene terephthalate (fiber B).

### Example 2

Composition of Nonwoven Molded Article:

60% by weight of wellene PET PPS 0104079 from Wellman-Indorama, a PET fiber containing fluorocarbon compounds (fiber A).

20% by weight of wellbond PET Bico M 1439 from Wellman-Indorama, which has a melting peak at about 110.6° C., a melting peak at about 154° C. (both sheath) and another melting peak at about 251.1° C. (core) in the DSC, the core consisting of polyethylene terephthalate (fiber B).

20% by weight of PET Bico HT PPS 0069718 from HUVIS, which has a melting peak at about 182.3° C. (sheath) and another melting peak at about 252.1° C. (core) in the DSC (fiber C).

PET is used as abbreviation for polyethylene terephthalate.

### Comparative Example 1

Composition of Nonwoven Molded Article:

60% by weight of wellene PET PPS 0104079 from Wellman-Indorama, a PET fiber containing fluorocarbon compounds

20% by weight of PP FR PPS 0103758 from Asota, a polypropylene fiber.

20% by weight of PET Bico HT PPS 0069718 from HUVIS, which has a melting peak at about 182.3° C. and another melting peak at about 252.1° C. in the DSC (fiber C).

### Comparative Example 2

Composition of Nonwoven Molded Article:

60% by weight of PET PPS 0010053-2 from Elana, which contains no fluorocarbon compounds.

20% by weight of PP FR 0103758 from Asota, a polypropylene fiber.

20% by weight of PET Bico HT PPS 0069718 from HUVIS, which has a melting peak at about 182.3° C. and another melting peak at about 252.1° C. in the DSC (fiber C).

The following tests were carried out with the abovementioned nonwoven molded articles:

Combustion test in accordance with ISO 3795:1989-10 in longitudinal direction (24 h at 23° C. and 50 R.F. Sample dimensions 356×102×2.0 mm; category SE/NBR).

The “water wicking” test is carried out as follows. In accordance with the test specification SAE J913:MAR2010, adopting point 3.2 (a), strips measuring 200 mm in length and 51 mm in width were cut with a cutter in longitudinal and transverse direction from the nonwoven molded article. The strips were then conditioned for 24 hours at 23° C.+/−2° C. and 50%+/−5% relative humidity. A liquid-resistant marker is then used to mark each strip with a line at a distance of 50 mm from one of the two narrow ends, and is placed into a suitable glass beaker so that each strip is in contact with the base, with the marking downward. In accordance with point 3.2 (a), a quantity of liquid such that the liquid level forms a meniscus within 2 mm of the marked line is then charged to each of the glass beakers. The duration of this procedure is to be 16 hours in a controlled environment at 23° C.+/−2° C. and 50%+/−5% relative humidity. At the end of the procedure after 16 hours, the strips are removed from the glass beaker and examined under a UV lamp. Migration of the fluorescent liquid beyond the 50 mm mark indicates the degree of wicking effect in mm.

The “water release” test is carried out as follows. In accordance with specification WSS-M99P32-D2, the component weight is determined, and the component is then immersed completely into a water bath at 23° C. for 1 h. After 1 h in the water bath, the component is dried for 24 h at room temperature and in installation position. The component weight is then again determined, and the percentage weight increase is calculated in comparison with the starting condition. Water release is calculated from the following equation: water release=100−weight increase [%].

TABLE 1
Results of tests

| | Ex. 1 | Ex. 2 | C Ex. 1 | C Ex. 2 |
|---|---|---|---|---|
| Combustion test | acc. | acc. | not acc. | not acc. |
| Water wicking | 0 mm | 0 mm | n.d. | n.d. |
| Water release | 100% | 100% | n.d. | n.d. |

Key:
n.d. = not determined
acc. = acceptable
not acc. = not acceptable

The nonwoven molded articles showed excellent results in the abovementioned tests. Because the comparative examples have already failed the combustion test, and were therefore unsuitable for use as material for wheel arch shells in road traffic, no further tests were carried out.

1. A nonwoven molded article comprising:
at least one thermoformed nonwoven fabric comprising:
structural fibers comprising Polyethylene terephthalate;
first bicomponent binder fibers comprising a matrix-forming polyethylene-terephthalate having a semicrystalline sheathing material; wherein the semicrystalline sheathing material has a melting point ranging from 90 to 175° C.;
optional second bicomponent binder fibers comprising a matrix-forming polyethylene-terephthalate having a semicrystalline sheathing material; wherein the second bicomponent binder fibers are different from the first bicomponent binder fibers; and
optional additives.

2. The nonwoven molded article according to claim 1, wherein the polyethylene terephthalate fibers comprise one or more of the following:
a melting point ranging from 220 to 265° C.;
a linear density ranging from 5.0 to 9.50 dtex measured in accordance with DIN EN ISO 1973:1995-12;
a fiber length ranging from 45 to 75 mm;
a crimping factor ranging from 1.5 to 10.0 bends/cm;
a tensile strength of 2.0 to 5.0 cN/dtex measured in accordance with DIN EN ISO 1973:1995-12; or
combinations thereof.

3. The nonwoven molded article according to claim 1, wherein the first bicomponent binder fibers comprise one or more of the following: a linear density of 4.0 to 10.0 dtex measured in accordance with DIN EN ISO 1973:1995-12;
a fiber length ranging from 45 to 70 mm;
a crimping factor ranging from 2.0 to 10.0 bends/cm;
a tensile strength ranging from 1.0 to 4.0 cN/dtex measured in accordance with DIN EN ISO 5079:1996-02; or
combinations thereof.

4. The nonwoven molded article according to claim 1, wherein the first bicomponent binder fibers comprise one or more of the following:
a core comprising polyethylene terephthalate or polyester;
a sheathing material with a melting range of 100 to 160° C.;
or combinations thereof.

5. The nonwoven molded article according to claim 1, wherein the proportion of the core in each of the first bicomponent binder fibers and/or second bicomponent binder fibers ranges from 50 to 70% by weight and the proportion of the sheathing material is in each case 30 to 50% by weight, based on the total weight of the respective fiber.

6. The nonwoven molded article according to claim 1, further comprising at least one polar compound having an oleophobic effect.

7. The nonwoven molded article according to claim 1, wherein the second bicomponent binder fibers comprise: a core comprising polyethylene terephthalate or polyester; a sheathing material with a melting range of 95 to 200° C.; a linear density ranging from 4.0 to 10.0 dtex measured in accordance with DIN EN ISO 1973:1995-12.

8. The nonwoven molded article according to claim 1, wherein the fibers are present in the following proportions by weight:
50 to 70% by weight of the structural fibers; first bicomponent binder fibers;
10 to 40% by weight of the first bicomponent binder fibers;
0 to 30% by weight of the second bicomponent binder fibers;
based on the total weight of the structural fibers, the first bicomponent binder fibers, and the second bicomponent binder fibers.

9. A multilayer nonwoven molded article comprising, a plurality of the at least one thermoformed nonwoven fabrics of claim 1; wherein the plurality of the at least one thermoformed nonwoven fabrics are arranged one above the other in a layer stack.

10. The nonwoven molded article according to claim 1 configured to form a textile wheel arch shell.

11. A process for the production of a nonwoven molded article according to claim 1, wherein the method comprises:
laying of at least one of the at least one thermoformed nonwoven fabric by a carding-cross lay process or an aerodynamic nonwoven-formation process,
needling the at least one laid thermoformed nonwoven fabric;
cutting the at least one needled thermoformed nonwoven fabric to size;
heating the at least one cut thermoformed nonwoven fabric; and
thermal shaping of the at least one heated thermoformed nonwoven fabric.

12. The process according to claim 11, wherein the at least one nonwoven fabric consists of 10 to 45 individual pile layers.

13. The process according to claim 11, wherein the heating occurs at a temperature ranging from 200 to 240° C.

14. The process according to claim 11, wherein the thermal shaping occurs at a temperature ranges from 7 to 15° C.

15. The nonwoven molded article according to claim 1 configured as a wheel arch shell, an underbody cladding, a trunk side wall, a parcel shelf, or combinations thereof.

16. The process according to claim 11, wherein the laying of at least one of the at least one thermoformed nonwoven fabric occurs by cross-laying.

17. The process according to claim 11, wherein the thermal shaping is thermoplastic shaping.

18. The nonwoven molded article according to claim 1, further comprising the second bicomponent binder fibers.

19. The nonwoven molded article according to claim 1, further comprising the additives.
